(19) United States
(12) Patent Application Publication
(10) Pub. No.: US 2025/0367607 A1
(43) Pub. Date: Dec. 4, 2025

(54) METHODS AND COMPOSITIONS FOR CONTROLLING BIOFOULING

(71) Applicant: Ecolab USA Inc., St. Paul, MN (US)

(72) Inventor: Seong Hoon YOON, Naperville, IL (US)

(73) Assignee: Ecolab USA Inc., St. Paul, MN (US)

(21) Appl. No.: 19/220,786

(22) Filed: May 28, 2025

Related U.S. Application Data
(60) Provisional application No. 63/654,856, filed on May 31, 2024.

(51) Int. Cl. B01D 65/08; B01D 61/02

(52) U.S. Cl. CPC B01D 65/08; B01D 61/025; B01D 2321/168

(57) ABSTRACT

The present disclosure provides methods of monitoring and controlling biocides in an aqueous medium, methods of manufacturing compositions containing the biocides, and various oxidizing biocide compositions suitable for use in aqueous medium treatment processes. Methods include adding first and second oxidizing biocides upstream of a reverse osmosis (RO) membrane inlet and measuring a free residual oxidant concentration and/or an oxidation-reduction potential downstream of the biocide addition but upstream of the RO membrane inlet. A reducing agent may optionally be added upstream of the RO membrane. The amount of biocide being added may be adjusted based on the free residual oxidant concentration and/or oxidation-reduction potential measurement.

### TECHNICAL FIELD

The present disclosure relates to methods, compounds, and compositions for controlling biofouling in aqueous mediums comprising a membrane.

### BACKGROUND

Biological fouling, or biofouling, is the accumulation of microorganisms, viscous liquids, and impurities on wet surfaces, such as membranes of membrane separation devices (e.g., a reverse osmosis (RO) membrane or nanofiltration membrane separation device) used to treat water. Biofouling of such membranes negatively impacts the membrane osmotic pressure. Biofouling also reduces the flow rate and quality of the water produced and increases the operation pressure and overall pressure drop of the system, which negatively affects the device operation. While cleaning chemicals are applied during device operation to mitigate biofouling, the negative operation impacts of biofouling will likely nonetheless reduce the service life of the membrane.

Microbial fouling of RO membranes is a challenge for wastewater recycle systems. While halogen based oxidizing biocides, such as sodium hypochlorite (NaClO), are used to mitigate biofouling in water treatment devices, they are generally not used to treat RO systems because the most widely used RO membranes, polyamide (PA) thin film composite (TFC) membranes, are susceptible to oxidative damaged by halogens. If halogens are present in the influent water, persistent exposure ultimately results in loss of membrane lifetime, as measured by increased passage of both salt and water.

Nonetheless, stabilized chlorine reagents may be used to treat waters of a RO process. When dosed or added into feed water, stabilized chlorine reagents release a small amount of active chlorine species, such as hypochlorous acid (HOCl). Such chlorine species can effectively eliminate microorganisms, and further, due to their very low concentration, their damaging effects to RO membranes are weak so they do not induce significant membrane damage.

A challenge with stabilized chlorine-based biocides, however, is that they have very limited biocidal effectiveness. In particular, these biocides can only maintain a biostatic environment and prevent further bacterial growth. In wastewater recycle systems where microbial growth potential is generally high, stabilized chlorine-based biocides have limited applications because they often do not have sufficient biocidal power to decrease microbes to desirable levels.

In contrast to chlorine-based reagents, bromine-based reagents have significantly greater biocidal effectiveness. Despite their increased effectiveness, one downside is that the resulting bromine species cause significantly faster and greater damage to RO membranes. As such, even in stabilized forms that result in slower release of damaging bromine species, bromine-based reagents induce too much damage to be generally compatible with RO membranes. Even trace amounts of bromine species generated in situ can damage RO membranes if the surrounding pH level is low.

### BRIEF SUMMARY

The present disclosure provides compounds, compositions, and methods for mitigating biofouling. In some embodiments, the present disclosure provides a method of monitoring and controlling biocides in an aqueous medium, comprising premixing a first oxidizing biocide with a second oxidizing biocide to form a composition; adding the composition to the aqueous medium at a first injection point upstream of a RO membrane inlet; obtaining a sample of the aqueous medium from a location downstream of the first injection point and upstream of the RO membrane inlet; measuring a free residual oxidant concentration of the sample using a reagent comprising N,N-diethyl-p-phenylenediamine (DPD); and adjusting addition of the composition so that the free residual oxidant concentration in the aqueous medium is less than about 0.1 ppm as Cl₂.

The present disclosure also provides a method of monitoring and controlling biocides in an aqueous medium, comprising premixing a first oxidizing biocide with a second oxidizing biocide to form a composition; adding the composition to the aqueous medium at a first injection point upstream of a RO membrane inlet; measuring an oxidation-reduction potential (ORP) at a first location downstream of the first injection point but upstream of the RO membrane inlet; and adjusting an amount of the composition being added to the aqueous medium to maintain the ORP at about 500 mV or less.

The present disclosure also provides a method of monitoring and controlling biocides in an aqueous medium, comprising adding a first oxidizing biocide at a first injection point upstream of a RO membrane inlet; adding a second oxidizing biocide at a second injection point upstream of the RO membrane inlet; obtaining a sample of the aqueous medium from a first location downstream of the first injection point and upstream of the RO membrane inlet; measuring a free residual oxidant concentration of the sample using a reagent comprising DPD; and adjusting addition of the first oxidizing biocide so that the free residual oxidant concentration in the sample is less than about 0.1 ppm as Cl₂.

Further, the present disclosure provides a method of monitoring and controlling biocides in an aqueous medium, comprising adding a first oxidizing biocide at a first injection point upstream of a RO membrane inlet; adding a second oxidizing biocide at a second injection point upstream of the RO membrane inlet; measuring an ORP at a first location downstream of the first injection point but upstream of the RO membrane inlet; and adjusting an amount of the first oxidizing biocide being added to the aqueous medium to maintain the ORP at about 500 mV or less.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

Various embodiments of the present disclosure are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

An “aqueous system” refers to any system containing one or more surfaces/components, which are in contact with an aqueous medium (e.g., water) on a periodic or continuous basis.

“Aqueous industrial system” means any system that circulates an aqueous medium or a medium including water as a component. Non-limiting examples of aqueous industrial systems include cooling systems, boiler systems, heating systems, membrane systems, paper making systems, food and beverage systems, oil and gas systems, and any other system that circulates or includes water. The presently disclosed technology may be used in any aqueous industrial system that includes a membrane separation device.

A medium of the present disclosure, such as a medium in an aqueous industrial system, may include, for example, produced water, fresh water, recycled water, salt water, surface water, condensed water, cooling water, injection water, wastewater, geothermal water, sewage water, nuclear cooling water, or any mixture thereof.

Described herein are biocidal chemicals and methods of making and using the chemicals to provide biocidal effectiveness in aqueous media without damaging RO membranes, resulting in advantages of increased device lifetimes and stability. Also disclosed are methods of monitoring and controlling biocides in an aqueous medium.

The aqueous medium includes water, such as wastewater. The aqueous medium also includes a membrane separation device. Illustrative, non-limiting examples of membranes in the membrane separation device include a RO membrane, a nanofiltration (NF) membrane, an ultrafiltration (UF) membrane, a microfiltration (MF) membrane, a semipermeable membrane, such as that used in an electrodialysis process, or any combination thereof. The form of the membrane separation device and/or membrane itself is not limited and any type of membrane module, such as spiral wound-type membrane module, hollow-fiber membrane module, tubular-type membrane module, plane-type membrane module, or any combination thereof, may be used.

Membranes of the present disclosure may comprise various polymers, such as polymers made from nitrogen-containing groups, e.g., aromatic polyamides, polyureas, polypiperazine-amides, or any combination thereof.

Such membrane separation devices can be used in the field of water treatment and can be used for preparation of other types of water, such as drinking water, pure water, ultra-pure grade water, process water for electricity generation, electronic method process water, semiconductor method process water, process water for medical field applications, water for chemical or biological agents, water for injection, aseptic pyrogen-free pure water, process water for food and beverage applications, chemical engineering and other engineering process water, water for boiler applications, water for washing and/or cooling, or any combination thereof. The membrane separation devices of the present disclosure may also be used in connection with desalination of seawater or brackish water.

Embodiments of the present disclosure include methods for inhibiting the biofouling growth in a membrane separation device for water treatment or removing, decreasing, or mitigating the biofouling on a membrane of a membrane separation device for water treatment. By applying the methods, compounds, and compositions of the present disclosure, the growth of biofouling can be effectively inhibited without damaging the filtration membrane itself.

An example of a method of monitoring and controlling biocides in an aqueous medium includes premixing a first oxidizing biocide with a second oxidizing biocide to form a composition, adding the composition to the aqueous medium at a first injection point upstream of a RO membrane inlet, obtaining a sample of the aqueous medium from a location downstream of the first injection point and upstream of the RO membrane inlet, measuring a free residual oxidant concentration of the sample using a reagent comprising DPD, and adjusting addition of the composition so that the free residual oxidant concentration in the aqueous medium is less than about 0.1 ppm as Cl₂.

The first and second oxidizing biocides are not particularly limited and may be independently selected from, for example, chlorosulfamate, bromosulfamate, iodosulfamate, chlorourea, chlorocyaurate, dichlorocyaurate, chlorohydantoin, chloramine, bromamine, NaOCl/Cl₂, NaOBr/Cl₂, an ethanolamine stabilized chlorine, an organic sulfamate stabilized chlorine, an ethanolamine stabilized bromine, an organic sulfamate stabilized bromine, and any combination thereof.

For example, the first oxidizing biocide may be selected from the group consisting of bromosulfamate, iodosulfamate, chlorocyaurate, dichlorocyaurate, chlorohydantoin, chloramine, bromamine, NaOCl/Cl₂, NaOBr/Cl₂, and any combination thereof.

In an illustrative, non-limiting embodiment, the second oxidizing biocide may comprise chlorosulfamate.

In some embodiments, the first and second oxidizing biocides are combined into a composition and that composition is added to the aqueous medium. The composition may comprise various amounts of each biocide in addition to other components, such as water. For example, the composition may comprise from about 0.1 w/w % to about 49 w/w % of the first oxidizing biocide, such as about 0.1 w/w % to about 45 w/w %, about 0.1 w/w % to about 40 w/w %, about 0.1 w/w % to about 35 w/w %, about 0.1 w/w % to about 30 w/w %, about 0.1 w/w % to about 25 w/w %, about 0.1 w/w % to about 20 w/w %, about 0.1 w/w % to about 15 w/w %, about 0.1 w/w % to about 10 w/w %, about 0.1 w/w % to about 5 w/w %, about 0.1 w/w % to about 1 w/w %, about 0.1 w/w % to about 0.5 w/w %, about 0.5 w/w % to about 49 w/w %, about 1 w/w % to about 49 w/w %, about 5 w/w % to about 49 w/w %, about 10 w/w % to about 49 w/w %, about 15 w/w % to about 49 w/w %, about 20 w/w % to about 49 w/w %, about 25 w/w % to about 49 w/w %, about 30 w/w % to about 49 w/w %, about 35 w/w % to about 49 w/w %, or about 40 w/w % to about 49 w/w %.

As additional examples, the composition may comprise from about 1 w/w % to about 99.9 w/w % of the second oxidizing biocide, such as about 1 w/w % to about 95 w/w %, about 1 w/w % to about 95 w/w %, about 1 w/w % to about 90 w/w %, about 1 w/w % to about 85 w/w %, about 1 w/w % to about 80 w/w %, about 1 w/w % to about 75 w/w %, about 1 w/w % to about 70 w/w %, about 1 w/w % to about 65 w/w %, about 1 w/w % to about 60 w/w %, about 1 w/w % to about 55 w/w %, about 1 w/w % to about 50 w/w %, about 1 w/w % to about 45 w/w %, about 1 w/w % to about 40 w/w %, about 1 w/w % to about 35 w/w %, about 1 w/w % to about 30 w/w %, about 1 w/w % to about 25 w/w %, about 1 w/w % to about 20 w/w %, about 1 w/w % to about 15 w/w %, about 1 w/w % to about 10 w/w %, about 1 w/w % to about 5 w/w %, about 1 w/w % to about 99 w/w %, about 5 w/w % to about 99 w/w %, about 10 w/w % to about 99 w/w %, about 15 w/w % to about 99 w/w %, about 20 w/w % to about 99 w/w %, about 25 w/w % to about 99 w/w %, about 30 w/w % to about 99 w/w %, about 35 w/w % to about 99 w/w %, about 40 w/w % to about 99 w/w %, about 45 w/w % to about 99 w/w %, about 50 w/w % to about 99 w/w %, about 55 w/w % to about 99 w/w %, about 60 w/w % to about 99 w/w %, about 65 w/w % to about 99 w/w %, about 70 w/w % to about 99 w/w %, about 75 w/w % to about 99 w/w %, about 80 w/w % to about 99 w/w %, about 85 w/w % to about 99 w/w %, about 90 w/w % to about 99 w/w %, or about 95 w/w % to about 99 w/w %.

A composition of the present disclosure may be added to the aqueous medium at a first injection point upstream of a RO membrane inlet and a free residual oxidant concentration of the aqueous medium may be measured. For example, the free residual oxidant concentration may be measured at a location between the first injection point and the RO membrane and/or a sample of the medium may be taken from a location between the first injection point and the RO membrane and the free residual oxidant concentration of the sample may be measured.

Measuring free residual oxidant concentration may be carried out, for example, by using a reagent comprising DPD. Reagents that include DPD are used to measure the biocide concentration by measuring one or both of total residual oxidant and free residual oxidant in a colorimetric assay method. In addition to DPD, a reagent of the present disclosure may comprise additional components, such as a buffering agent and/or a chelating agent. The buffering agent may comprise, for example, a phosphate and/or a carboxylic acid. The chelating agent may comprise, for example, ethylenediaminetetraacetic acid (EDTA).

Total residual oxidant includes total halogen, in both stabilized and free forms, from the first oxidizing biocide and the second oxidizing biocide. The free residual oxidant measurement can be used to estimate the total amount of the oxidizing halogen from the first and/or second oxidizing biocides in both stabilized and free forms. Thus, sample measurements, for example, can be applied at various points between biocide injection locations and the RO membrane inlet to determine the consumption rate of one or both of the oxidizing biocides. Measurements may be taken on a continuous or intermittent basis, automatically and/or manually.

After the free residual oxidant concentration is measured, the amount of the composition being added to the aqueous medium may be adjusted. For example, if the amount of free residual oxidant concentration in the aqueous medium is greater than about 0.1 ppm as Cl₂, the amount of the composition being added to the medium may be reduced until the measured amount of free residual oxidant concentration in the aqueous medium is less than about 0.1 ppm as Cl₂. In some cases, if the amount of free residual oxidant concentration in the aqueous medium is greater than about 0.05 ppm or about 0.03 ppm as Cl₂, the amount of the composition being added to the medium may be reduced until the measured amount of free residual oxidant concentration in the aqueous medium is less than about 0.05 ppm or about 0.03, respectively, as Cl₂.

In addition to, or instead of, measuring free residual oxidant concentration, methods of the present disclosure may include measuring an ORP of the aqueous medium. For example, ORP may be measured at a first location downstream of a biocide injection point but upstream of an RO membrane inlet. Measurements may also be taken at more than one location between the RO membrane and the biocide injection point. The amount of the composition being added to the aqueous medium may be adjusted based on the ORP measurement.

For example, if the ORP of the aqueous medium is greater than about 500 mV, the amount of the composition being added to the medium may be reduced until the measured ORP of the aqueous medium is less than about 500 mV. In some cases, if the ORP of the aqueous medium is greater than about 400 mV or about 300 mV, the amount of the composition being added to the medium may be reduced until the measured ORP of the aqueous medium is less than about 400 mV or about 300 mV, respectively. ORP measurements may be taken on a continuous or intermittent basis, automatically and/or manually, using any means known in the art, such as an ORP probe submerged in the aqueous medium.

In accordance with the methods disclosed herein, a reducing agent may also be added to the aqueous medium upstream of the RO membrane and upstream and/or downstream of a biocide injection point. For example, in addition to or instead of reducing an amount of the composition being added to the aqueous medium if the free residual oxidant concentration in the aqueous medium and/or if the ORP of the aqueous medium is too high, a reducing agent may be added to the aqueous medium at a second injection point upstream of the RO membrane inlet but downstream of a biocide injection point. The reducing agent is not particularly limited and may be selected from, for example, a sulfite, a bisulfite, a thiosulfate, sulfur dioxide, hydrogen peroxide, and any combination thereof.

While the foregoing methods have focused on combining a first oxidizing biocide with a second oxidizing biocide to form a composition and adding the composition to the aqueous medium, the present disclosure also contemplates adding the first and second oxidizing biocides separately to the aqueous medium.

For example, a method of the present disclosure may comprise adding a first oxidizing biocide at a first injection point upstream of a RO membrane inlet and adding a second oxidizing biocide at a second injection point upstream of the RO membrane inlet. The first injection point may be upstream or downstream of the second injection point. Alternatively, the first and second injection points may be equidistant from the RO membrane inlet.

The method may further comprise obtaining a sample of the aqueous medium from a first location downstream of the first and/or second injection points and upstream of the RO membrane inlet, measuring a free residual oxidant concentration of the sample using a reagent comprising DPD, and adjusting addition of the first oxidizing biocide so that the free residual oxidant concentration in the sample is less than about 0.1 ppm as Cl₂.

A method of the present disclosure may also comprise measuring an ORP, in addition to or instead of measuring free residual oxidant concentration, at a first location downstream of the first and/or second injection points but upstream of the RO membrane inlet. The amount of the first oxidizing biocide being added to the aqueous medium may be adjusted to maintain the ORP at about 500 mV or less.

As previously mentioned, a reducing agent may also be added to the aqueous medium upstream of the RO membrane and upstream and/or downstream of the first and/or second biocide injection points. For example, in addition to or instead of reducing an amount of the first oxidizing biocide being added to the aqueous medium if the free residual oxidant concentration in the aqueous medium and/or if the ORP of the aqueous medium is too high, a reducing agent may be added to the aqueous medium at an injection point upstream of the RO membrane inlet but downstream of a biocide injection point.

In accordance with any method disclosed herein, an amount of the first oxidizing biocide (as Cl₂) in the aqueous medium may be between about 10 ppb and about 100 ppm, such as between about 10 ppb and about 80 ppm, about 10 ppb and about 60 ppm, about 10 ppb and about 40 ppm, about 10 ppb and about 20 ppm, about 10 ppb and about 10 ppm, about 10 ppb and about 1 ppm, about 25 ppb and about 100 ppm, about 50 ppb and about 100 ppm, about 75 ppb and about 100 ppm, or about 100 ppb and about 100 ppm.

In accordance with any method disclosed herein, an amount of the second oxidizing biocide (as Cl₂) in the aqueous medium may be between about 10 ppb and about 100 ppm, such as between about 10 ppb and about 80 ppm, about 10 ppb and about 60 ppm, about 10 ppb and about 40 ppm, about 10 ppb and about 20 ppm, about 10 ppb and about 10 ppm, about 10 ppb and about 1 ppm, about 25 ppb and about 100 ppm, about 50 ppb and about 100 ppm, about 75 ppb and about 100 ppm, or about 100 ppb and about 100 ppm.

In some embodiments, a biocide or a mixture of biocides may be added to the aqueous medium to provide a biocide concentration between about 0.05 ppm to 20 ppm (as Cl₂), which may be measured by the DPD (total) reagent at the point of injection. Optionally, a biocide mixture may be split and injected at multiple points along the aqueous medium flow.

In accordance with any method disclosed herein, an amount of the reducing agent in the aqueous medium may be between about 10 ppb and about 100 ppm, such as between about 10 ppb and about 80 ppm, about 10 ppb and about 60 ppm, about 10 ppb and about 40 ppm, about 10 ppb and about 20 ppm, about 10 ppb and about 10 ppm, about 10 ppb and about 1 ppm, about 25 ppb and about 100 ppm, about 50 ppb and about 100 ppm, about 75 ppb and about 100 ppm, or about 100 ppb and about 100 ppm.

If the first and second oxidizing biocides are added separately to the aqueous medium, the first oxidizing biocide may be added before, after, and/or simultaneously with the second oxidizing biocide. Biocide addition may be continuous or intermittent, manual and/or automatic. Biocide addition points may be at substantially the same location, substantially the same distance from an inlet of a RO membrane or the first biocide injection point may be farther or closer to the inlet of the RO membrane than the second biocide injection point.

When the first oxidizing biocide and the second oxidizing biocide are injected into the aqueous medium, they react with organic materials, such as natural organic matter (NOM), microorganisms, and their extracellular polymeric substances (EPS), for example.

Inorganic compounds, such as ammonia, sulfite, ferrous, and manganese ions, and the like, also may react with these oxidizing biocides. In accordance with certain embodiments, the first oxidizing biocide may be more reactive and consumed at a faster rate than the second oxidizing biocide. The consumption rate of the oxidizing biocides may be dependent on, for example, the nature and concentration of organic and inorganic molecules in the aqueous medium. The aqueous medium properties, such as pH and temperature, and the nature of stabilizers in the first and second oxidizing biocides also play important roles.

The complete consumption of the first oxidizing biocide can range from nearly instantly (e.g., about 1, 5, 10, 15, 20, 25, 30, 35, 40, 45, 50, 55, or 60 seconds after injection into the medium) to longer periods of time (e.g., about 2 minutes, about 5 minutes, about 15 minutes, about 30 minutes, about 60 minutes, about 2 hours, about 3 hours, about 4 hours, about 5 hours, or more after injection). In embodiments, the first oxidizing biocide is completely or substantially completely consumed before it reaches the RO membrane.

On the other hand, consumption of the second oxidizing biocide may take longer than consumption of the first oxidizing biocide. For example, consumption of the second oxidizing biocide may take from a few minutes, such as about 5, 10, 15, 20, 25, 30, 35, 40, 45, 50, 55, or 60 minutes after injection into the medium to longer periods of time, such as about 2 hours, about 3 hours, about 4 hours, about 5 hours, or more after injection. In certain embodiments, the second oxidizing biocide may not be completely consumed before it reaches the RO membrane and as such, it may contact and/or pass through the RO membrane.

The first oxidizing biocide may rapidly induce biocidal effects on microorganisms present in the system, while the second oxidizing biocide may prevent the regrowth of these microorganisms.

In accordance with any of the methods disclosed herein, a biocide injection point, such as the first biocide injection point or the second biocide injection point, may be before a cartridge filter, a feeding tank, an ion-exchange unit, an activated carbon filtration unit, a microfiltration unit, an ultrafiltration unit, and/or a sand filtration unit.

Any method disclosed herein may be carried out on-line. For example, a method may include an on-line unit and system for measuring, controlling, and/or optimizing one or more system parameters or properties of the aqueous medium, such as ORP. Optimization can include, for example, measuring one or more properties associated with the water, such as ORP, to be sure that the one or more properties are within an acceptable, predetermined range and, if the one or more properties are not within the acceptable, predetermined range for each respective property being measured, causing a change in the medium to bring the property back within the acceptable, predetermined range.

In certain embodiments, the system includes a monitoring and controlling unit that comprises a controller and one or more sensors. Each of the sensors can be in communication with the controller. For example, if the unit comprises five sensors, each of the five sensors can be in communication with the controller. In certain aspects, the controller can be attached to a skid, or other type of support member, to allow for mobility.

As used herein, the term “controller” refers to a manual operator or an electronic device having components, such as a processor, memory device, digital storage medium, a communication interface including communication circuitry operable to support communications across any number of communication protocols and/or networks, a user interface (e.g., a graphical user interface that may include cathode ray tube, liquid crystal display, plasma display, touch screen, or other monitor), and/or other components.

The controller is preferably operable for integration with one or more application-specific integrated circuits, programs, computer-executable instructions or algorithms, one or more hard-wired devices, wireless devices, and/or one or more mechanical devices. Moreover, the controller is operable to integrate the feedback, feed-forward, and/or predictive loop(s) of the invention. Some or all of the controller system functions may be at a central location, such as a network server, for communication over a local area network, wide area network, wireless network, internet connection, microwave link, infrared link, wired network (e.g., Ethernet) and the like. In addition, other components, such as a signal conditioner or system monitor, may be included to facilitate signal transmission and signal-processing algorithms.

In certain aspects, the controller includes hierarchy logic to prioritize any measured or predicted properties associated with system parameters. For example, the controller may be programmed to prioritize system ORP over pH, or vice versa. It should be appreciated that the object of such hierarchy logic is to allow improved control over the system parameters and to avoid circular control loops.

In some embodiments, the monitoring and controlling unit and method associated therewith includes an automated controller. In some embodiments, the controller is manual or semi-manual. For example, when the system includes one or more datasets received from one or more sensors in the system, the controller may either automatically determine which data points/datasets to further process or an operator may partially or fully make such a determination. A dataset for an aqueous industrial system, for instance, may include variables or system parameters such as ORP, dissolved oxygen (DO), conductivity, pH, turbidity, concentrations of certain chemicals, such as biocides, scale inhibitors, friction reducers, acids, bases, and/or oxygen scavengers, levels of ions (e.g., determined empirically, automatically, fluorescently, electrochemically, colorimetrically, measured directly, calculated), temperature, pressure, flow rate, total dissolved or suspended solids, etc. Such system parameters are typically measured with any type of suitable data capturing equipment, such as sensors designed specifically for these parameters, e.g., pH sensors, ORP probes/sensors, ion analyzers, temperature sensors, thermocouples, pressure sensors, corrosion probes, and/or any other suitable device or sensor. Data capturing equipment is in communication with the controller and, according to some embodiments, may have advanced functions (including any part of the control algorithms described herein) imparted by the controller.

The monitoring and controlling unit may comprise one or more sensors, which are capable of analyzing the medium and transmitting data regarding the medium to the controller. Sensors of the present disclosure may include, for example, a sensor for measuring conductivity, pH, ORP, biocide concentration, turbidity, temperature, flow, and/or DO in the medium. The monitoring and controlling unit may comprise any one of these sensors, all of these sensors, a combination of two or more of these sensors, one or more additional sensors not specifically mentioned here, and the sensors may be in communication with the controller. Other types of sensors contemplated by the present disclosure include, but are not limited to, oil in water sensors, total dissolved solids sensors, and total suspended solids sensors.

The presently disclosed monitoring and controlling system comprises, in certain embodiments, one or more chemical injection pumps. Each chemical injection pump may be in fluid communication with a storage device. Each storage device may comprise one or more chemicals, such as a first oxidizing biocide, a second oxidizing biocide, a mixture of the first and second biocides, or a reducing agent, and optionally water, and the chemical injection pumps may transport those chemicals into the aqueous medium. In some embodiments, the chemical injection pump comprises the storage device. The chemical injection pumps may be in communication with the controller in any number of ways, such as through any combination of wired connection, a wireless connection, electronically, cellularly, through infrared, satellite, or according to any other types of communication networks, topologies, protocols, standards and more. Accordingly, the controller can send signals to the pumps to control their chemical feed rates.

In certain embodiments, the monitoring and controlling system is implemented to have the one or more sensors provide continuous or intermittent feedback, feed-forward, and/or predictive information to the controller, which can relay this information to a relay device, such as the Nalco Global Gateway, which can transmit the information via cellular communications to a remote device, such as a cellular telephone, computer, and/or any other device that can receive cellular communications. This remote device can interpret the information and automatically send a signal (e.g., electronic instructions) back, through the relay device, to the controller to cause the controller to make certain adjustments to the output of the pumps. The information can also be processed internally by the controller and the controller can automatically send signals to the pumps to adjust the amount of chemical injection, for example. Based upon the information received by the controller from the one or more sensors or from the remote device, the controller may transmit signals to the various pumps to make automatic, real-time adjustments, to the amount of chemical that the pumps are injecting into the medium.

Alternatively, an operator of the remote device that receives cellular communications from the controller can manually manipulate the pumps through the remote device. The operator may communicate instructions, through the remote device, cellularly or otherwise, to the controller and the controller can make adjustments to the rate of chemical addition of a chemical injection pump. For example, the operator can receive a signal or alarm from the remote device through a cellular communication from the controller and send instructions or a signal back to the controller using the remote device to turn on one or more of the chemical injection pumps, turn off one or more of the chemical injection pumps, increase or decrease the amount of chemical being added to the medium by one or more of the injection pumps, or any combination of the foregoing. The controller and/or the remote device is also capable of making any of the foregoing adjustments or modifications automatically without the operator actually sending or inputting any instructions. Preset parameters or programs are entered into the controller or remote device so that the controller or remote device can determine if a measured property, such as ORP, is outside of an acceptable range. Based on the information received by the one or more sensors, the controller or remote device can make appropriate adjustments to a pump or send out an appropriate alert.

In certain embodiments, the remote device or controller can include appropriate software to receive data from the one or more sensors and determine if the data indicates that one or more measured properties of the water are within, or outside, an acceptable range. The software can also allow the controller or remote device to determine appropriate actions that should be taken to remedy the property that is outside of the acceptable range. For example, if the measured ORP is above the acceptable range, such as greater than about 500 mV, the software allows the controller or remote device to make this determination and take remedial action, such as alerting a pump to increase the flow of a reducing agent into the aqueous medium.

The monitoring and controlling system and/or controller disclosed herein can incorporate programming logic to convert analyzer signals from the one or more sensors to pump adjustment logic and, in certain embodiments, control one or more of the chemical injection pumps with a unique basis.

The sensors disclosed herein are operable to sense and/or predict a property associated with the medium or system parameter and convert the property into an input signal, e.g., an electric signal, capable of being transmitted to the controller. A transmitter associated with each sensor transmits the input signal to the controller. The controller is operable to receive the transmitted input signal, convert the received input signal into an input numerical value, analyze the input numerical value to determine if the input numerical value is within an optimum range, generate an output numerical value, convert the output numerical value into an output signal, e.g., an electrical signal, and transmit the output signal to a receiver, such as a pump incorporating such receiver capabilities or a remote device, such as a computer or cellular telephone, incorporating receiver capabilities. The receiver receives the output signal and either alerts an operator to make adjustments to the flow rate of a pump, or the receiver can be operable to cause a change in a flow rate of a pump automatically, if the output numerical value is not within the acceptable range for that property.

The method is optionally repeated for a plurality of different system parameters, where each different system parameter has a unique associated property, or, alternatively, all system parameters can be analyzed concurrently by the one or more sensors.

Data transmission of measured parameters or signals to chemical pumps, alarms, remote monitoring devices, such as computers or cellular telephones, or other system components is accomplished using any suitable device, and across any number of wired and/or wireless networks, including as examples, WiFi, WiMAX, Ethernet, cable, digital subscriber line, Bluetooth, cellular technologies (e.g., 2G, 3G, Universal Mobile Telecommunications System (UMTS), GSM, Long Term Evolution (LTE), or more) etc. The Nalco Global Gateway is an example of a suitable device. Any suitable interface standard(s), such as an Ethernet interface, wireless interface (e.g., IEEE 802.11a/b/g/x, 802.16, Bluetooth, optical, infrared, radiofrequency, etc.), universal serial bus, telephone network, the like, and combinations of such interfaces/connections may be used.

As used herein, the term “network” encompasses all of these data transmission methods. Any of the described devices (e.g., archiving systems, data analysis stations, data capturing devices, process devices, remote monitoring devices, chemical injection pumps, etc.) may be connected to one another using the above-described or other suitable interface or connection.

In some embodiments, system parameter information is received from the system and archived. In certain embodiments, system parameter information is processed according to a timetable or schedule. In some embodiments, system parameter information is immediately processed in real-time or substantially real-time. Such real-time reception may include, for example, “streaming data” over a computer network.

The chemicals to be added to the system, such as the oxidizing biocides, the reducing agent, etc., may be introduced to the system using any suitable type of chemical injection pump. Most commonly, positive displacement injection pumps are used and are powered either electrically or pneumatically. Continuous flow injection pumps can also be used to ensure specialty chemicals are adequately and accurately injected into the rapidly moving process stream. Though any suitable pump or delivery system may be used, examples of pumps and pumping methods include those disclosed in U.S. Pat. No. 5,066,199, titled “Method for Injecting Treatment Chemicals Using a Constant Flow Positive Displacement Pumping Apparatus” and U.S. Pat. No. 5,195,879, titled “Improved Method for Injecting Treatment Chemicals Using a Constant Flow Positive Displacement Pumping Apparatus,” each incorporated herein by reference in its entirety.

In some embodiments, changes in the chemical injection pumps are limited in frequency. In some aspects, adjustment limits are set at a maximum of 1 per 15 min and sequential adjustments in the same direction may not exceed 8, for example. In some embodiments, after 8 total adjustments or a change of 50% or 100%, the pump could be suspended for an amount of time (e.g., 2 or 4 hours) and alarm could be triggered. If such a situation is encountered, it is advantageous to trigger an alarm to alert an operator. Other limits, such as maximum pump output, may also be implemented. It should be appreciated that it is within the scope of the present disclosure to cause any number of adjustments in any direction without limitation. Such limits are applied as determined by the operator or as preset into the controller.

In accordance with certain embodiments of the present disclosure, a method of monitoring and controlling one or more properties of an aqueous industrial system is provided. The properties can be, for example, ORP, pH, biocide concentration, conductivity, turbidity, flow, etc.

The method includes the use of a monitoring and controlling unit comprising a controller and one or more sensors in communication with the controller. Each sensor is operable to measure a property of the water. For example, in some embodiments, the unit comprise a sensor operable to measure ORP.

One or more pumps, which are in communication with the controller, are utilized to inject various chemicals, such as biocides and/or reducing agents, into the medium. Each chemical may have its own chemical injection pump or, in some embodiments, multiple biocides, such as a first and second biocide, may be combined in a single drum, which is controlled by a single chemical injection pump.

An acceptable range for each of the one or more properties of the medium to be measured is entered into the controller. For example, a range of less than about 500 mV may be entered into the controller for the ORP of the medium.

A conduit may be provided between the aqueous industrial system and the monitoring and controlling unit. A sample of water passes through the conduit and into an inlet of the monitoring and controlling unit. Next, one or more properties of the water are measured using one or more sensors and the controller determines if the measured one or more properties are within the acceptable range entered into the controller in the previous step. This determining step can be automatically performed by the controller and in this step, the measured value for each measured property is compared to the acceptable range entered for that specific property.

If the measured one or more properties are outside of the acceptable range associated with that property, such as greater than about 500 mV for ORP, the controller and/or operator of the controller may cause a change, for example, in an influx of a chemical, such as reducing agent, into the aqueous industrial system from the one or more chemical injection pumps, the chemical(s) being capable of adjusting the measured property and bringing it back within the acceptable range. The controller is operable to determine when the measured property is back within the acceptable range and subsequently turn off the chemical injection pump(s).

Additionally, the controller may cause a chemical injection pump to inject a reduced amount of a chemical, such as a biocide or biocide mixture, into the medium until the measured property, such as ORP, is back within the acceptable range, such as below about 500 mV.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a biocide” is intended to include “at least one biocide” or “one or more biocides.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of monitoring and controlling biocides in an aqueous medium, comprising:
premixing a first oxidizing biocide with a second oxidizing biocide to form a composition;
adding the composition to the aqueous medium at a first injection point upstream of a reverse osmosis (RO) membrane inlet;
obtaining a sample of the aqueous medium from a location downstream of the first injection point and upstream of the RO membrane inlet;
measuring a free residual oxidant concentration of the sample using a reagent comprising N,N-diethyl-p-phenylenediamine (DPD); and
adjusting addition of the composition so that the free residual oxidant concentration in the aqueous medium is less than about 0.1 ppm as Cl₂.

2. The method of claim 1, wherein the reagent further comprises a buffering agent, a chelating agent, or any combination thereof.

3. The method of claim 1, wherein the first and second oxidizing biocides are independently selected from the group consisting of chlorosulfamate, bromosulfamate, iodosulfamate, chlorourea, chlorocyaurate, dichlorocyaurate, chlorohydantoin, chloramine, bromamine, NaOCl/Cl₂, NaOBr/Cl₂, ethanolamine, or organic sulfamate, and any combination thereof.

4. The method of claim 1, wherein the second oxidizing biocide comprises chlorosulfamate.

5. The method of claim 1, further comprising adding a reducing agent to the aqueous medium at a second injection point upstream of the RO membrane inlet but downstream of the first injection point.

6. The method of claim 5, wherein the reducing agent is selected from the group consisting of a sulfite, a bisulfite, a thiosulfate, sulfur dioxide, hydrogen peroxide, and any combination thereof.

7. The method of claim 1, wherein the composition comprises about 0.1 w/w % to about 49 w/w % of the first oxidizing biocide and about 1 w/w % to about 99.9 w/w % of the second oxidizing biocide.

8. The method of claim 1, wherein the aqueous medium comprises wastewater.

9. The method of claim 1, wherein the first injection point and/or the second injection point is before a cartridge filter, a feeding tank, an ion-exchange unit, an activated carbon filtration unit, a microfiltration unit, an ultrafiltration unit, and/or a sand filtration unit.

10. The method of claim 1, further comprising consuming the first oxidizing biocide before it reaches the RO membrane inlet.

11. The method of claim 1, further comprising adjusting the addition of the composition so that the free residual oxidant concentration in the aqueous medium is less than about 0.05 ppm or about 0.03 ppm as Cl₂.

12. A method of monitoring and controlling biocides in an aqueous medium, comprising:
premixing a first oxidizing biocide with a second oxidizing biocide to form a composition;
adding the composition to the aqueous medium at a first injection point upstream of a RO membrane inlet;
measuring an oxidation-reduction potential (ORP) at a first location downstream of the first injection point but upstream of the RO membrane inlet; and
adjusting an amount of the composition being added to the aqueous medium to maintain the ORP at about 500 mV or less.

13. The method of claim 12, wherein the first and second oxidizing biocides are independently selected from the group consisting of chlorosulfamate, bromosulfamate, iodosulfamate, chlorourea, chlorocyaurate, dichlorocyaurate, chlorohydantoin, chloramine, bromamine, NaOCl/Cl₂, NaOBr/Cl₂, ethanolamine, or organic sulfamate, and any combination thereof.

14. The method of claim 12, further comprising adding a reducing agent to the aqueous medium at a second injection point upstream of the RO membrane inlet but downstream of the first injection point.

15. The method of claim 12, wherein the composition comprises about 0.1 w/w % to about 49 w/w % of the first oxidizing biocide and about 1 w/w % to about 99.9 w/w % of the second oxidizing biocide.

16. The method of claim 12, wherein the first injection point and/or the second injection point is before a cartridge filter, a feeding tank, an ion-exchange unit, an activated carbon filtration unit, a microfiltration unit, an ultrafiltration unit, and/or a sand filtration unit.

17. The method of claim 12, further comprising consuming the first oxidizing biocide before it reaches the RO membrane inlet.

18. The method of claim 12, further comprising adjusting the amount of the composition being added to the aqueous medium to maintain the ORP at about 400 mV or less or about 300 mV or less.

19. A method of monitoring and controlling biocides in an aqueous medium, comprising:
adding a first oxidizing biocide at a first injection point upstream of a RO membrane inlet;
adding a second oxidizing biocide at a second injection point upstream of the RO membrane inlet;
obtaining a sample of the aqueous medium from a first location downstream of the first injection point and upstream of the RO membrane inlet;
measuring a free residual oxidant concentration of the sample using a reagent comprising DPD; and
adjusting addition of the first oxidizing biocide so that the free residual oxidant concentration in the sample is less than about 0.1 ppm as Cl₂.

20. The method of claim 19, further comprising adding a reducing agent to the aqueous medium at a third injection point upstream of the RO membrane inlet but downstream of the first and second injection points, optionally wherein the reducing agent is selected from the group consisting of a sulfite, a bisulfite, a thiosulfate, sulfur dioxide, hydrogen peroxide, and any combination thereof.
